(19) United States
(12) Patent Application Publication
(10) Pub. No.: US 2010/0051556 A1
(43) Pub. Date: Mar. 4, 2010

(54) Methods of purifiying water using waste brines to regenerate ion-exchange resins

(76) Inventor: Gerald J. Grott, Phoenix, AZ (US)

Correspondence Address: THE LUTHER LAW FIRM, PLC, 10575 N 114TH STREET, SUITE 103, SCOTTSDALE, AZ, 85259, US

(21) Appl. No.: 12/231,125

(22) Filed: Aug. 29, 2008

(51) Int. Cl. C02F 1/42; B01J 49/00

(52) U.S. Cl. 210/673

(57) ABSTRACT

Water is purified by ion-exchange. The ion-exchange resins are regenerated by contacting the resins with waste brines previously discarded, thus to improve the economics of discarding the waste brines and, in appropriate cases, providing for recovery of valuable by-products.

### FIELD OF THE INVENTION

This invention relates to methods for purifying water.

More particularly, the invention relates to such methods in which waste brine waters are used to regenerate ion-exchange resins used in water purification.

The invention concerns such methods which provide for economic use of waste brine waters that formerly were discarded at significant cost.

In another respect, the invention concerns such methods which yield valuable and useful by-products, thus reducing the net cost of disposing of the original waste brine waters.

### BACKGROUND OF THE INVENTION

There are many instances of the need to economically dispose of, use or reuse various waste brine waters from agricultural operations, crude oil production operations, chemical plant operations and the like.

For example one of the large producers of crude oil in the Permian Basin of West Texas must dispose of (by reinjection) waste brines having from about 120,000-160,000 total dissolved solids (“TDS”). The electrical power to perform this reinjection costs from about $5,000-$10,000 per day, depending on whether the producer generates the electrical power or whether it is purchased from an electrical utility.

Other examples of waste brines include spent brines from water softening by cation exchange, waste brines from membrane purification of water, waste salty ground and surface waters, spent brines from electrolytic caustic-chlorine processes, from water “hardening” processes by cation exchange and waste waters from cooling towers and other evaportive cooling processes.

Accordingly, it would be highly desirable to find ways in which the waste brines from various sources can be employed in water purification in order, thus improving the economics of disposing of these wastes, by providing interim uses of these brine and/or providing useful byproducts before ultimate disposal of the brine.

### BRIEF DESCRIPTION OF THE INVENTION

According to my invention, I provide a method of ion-exchange purification of contaminated water containing undesired ionic impurities. My method includes the steps, in combination, first, contacting the contaminated water with an ion-exchange resin loaded with beneficial ions to reduce the concentration of the undesired ionic impurities in the water, thus to increase the beneficial ion content of the water and increase the content of the undesired impurity ions in the resin. In the next step the resin is regenerated by reducing the content of the undesired impurities in the resin and increasing the content of beneficial ions in the resin. This is accomplished by contacting the resin with a waste brine containing an excess of beneficial ions in comparison to undesired ions. In the final step, the regenerated resin is contacted with additional contaminated water to repeat the first step.

In a preferred embodiment of the invention, I use the concentrate from membrane purification of water as the waste brine to regenerate resins used in anion exchange purification of water, e.g., to remove arsenic, nitrates, perchlorates and the like.

### DEFINITIONS

As used herein the following terms have the indicated meanings:

“Waste brine” means an aqueous solution comprising at least about 2% by weight of at least one member of the group consisting of the chloride, sulphate and/or carbonate salts of sodium, calcium and/or magnesium.

### BRIEF DESCRIPTION OF THE DRAWINGS

FIG. 1 is a flowsheet depicting the overall generalized method of the invention;

FIG. 2 is a flowsheet depicting a presently preferred embodiment of the method of the invention using spent brine from an electrolytic caustic-chlorine process to regenerate the ion-exchange resin used in an ion-exchange water purification process.

FIG. 3 is a flow sheet depicting use of waste brine from anion exchange purification of water (removal of nitrates, perchlorates, arsenic, etc), used a second time to regenerate cation exchange resins used in water purification by cation exchange, such as in water softening, water hardening, etc.

### DETAILED DESCRIPTION OF THE INVENTION

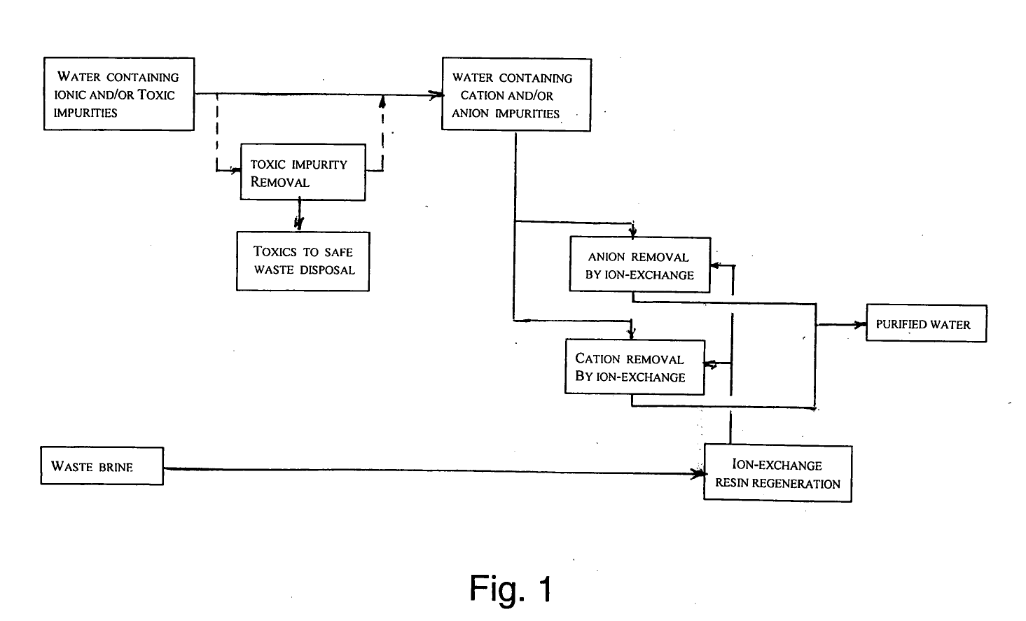

Referring now to FIG. 1, water containing ionic and/or toxic impurities such as hydrocarbons, animal waste, etc. is first subjected (as indicated by the dashed lines) to toxic impurity removal according to various art-recognized techniques such as membrane purification. The detoxified water, containing the ionic impurities is then processed for anion removal by anion exchange and/or cation exchange according to art-recognized techniques. The resins used in the ion removal steps are regenerated by contacting the resins with waste brine containing the requisite regenerating ions. Ion removal results in the final purified water end product.

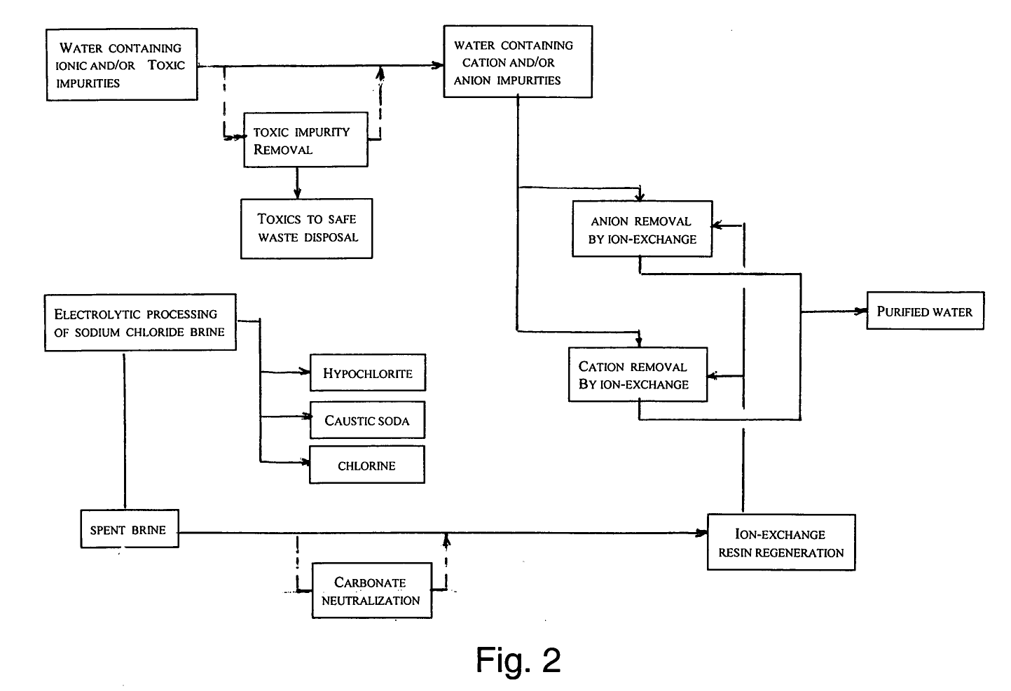

FIG. 2 depicts in greater detail a presently preferred embodiment of the methods of water purification of the invention. A typical electrochemical chlorine-caustic process is used to produce various products such as caustic soda, chlorine and/or hypochlorite bleaching or water purification products. The “spent” brine from the caustic-chlorine process, containing appropriate dissolved ions, is first treated (if necessary, as indicated by the dashed lines) to neutralize dissolved carbonates. The treated brine is then used to regenerate the ion-exchange resins used in the purification process exemplified by FIG. 1.

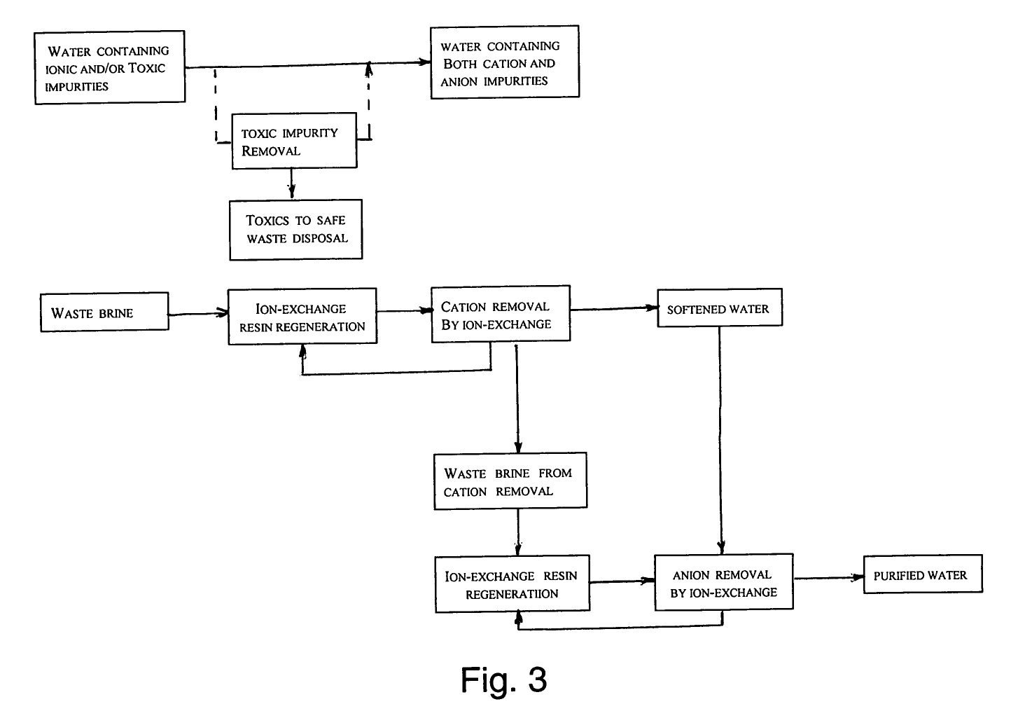

FIG. 3 depicts another embodiment of the invention in which the waste brine is first used to regenerate ion-exchange resins used in removing cations from water containing both cationic and anionic impurities. After any necessary toxic impurity treatment, the water is then subjected to cation removal, resulting in a “softened” water intermediate product. The waste brine from the cation removal step is used again to regenerate the resins used in removing the cationic impurities, resulting in the final purified water product.

Having disclosed my invention in such terms as to enable those skilled in the art to understand and practice it and, having identified the presently preferred embodiments thereof, I CLAIM:

1. In the ion-exchange purification of contaminated water containing undesired ionic impurities, the steps, in combination, comprising:
(a) contacting said contaminated water with an ion-exchange resin loaded with beneficial ions, to
(i) reduce the concentration of said undesired ionic impurities in said contaminated water,
(ii) increase the beneficial ion content of said water, and
(iii) increase the content of said undesired impurities in said resin;
(b) regenerating said resin to increase the content of beneficial ions in said resin by contacting said resin with an aqueous brine containing both beneficial and undesired ions, said aqueous brine having an excess of said beneficial ions in comparison to said undesired ions; and
(c) contacting regenerated resin from step (b) with additional contaminated water in step (a).
